(19) United States
(12) Patent Application Publication
(10) Pub. No.: US 2026/0254134 A1
(43) Pub. Date: Aug. 27, 2026

(54) Conductive Terminal Assembly and Connector

(71) Applicants: Tyco Electronics (Suzhou) Ltd., Suzhou City (CN); Tyco Electronics (Shanghai) Co., Ltd., Shanghai (CN)

(72) Inventors: Feng (Charles) Wan, Shanghai (CN); Limin Gao, Suzhou (CN); Kai (Rik) Chen, Suzhou (CN); Zhaowen Zhou, Shanghai (CN)

(73) Assignees: Tyco Electronics (Suzhou) Ltd., Suzhou City (CN); Tyco Electronics (Shanghai) Co., Ltd., Shanghai (CN)

(21) Appl. No.: 19/221,734

(22) Filed: May 29, 2025

(30) Foreign Application Priority Data
May 30, 2024 (CN) 202410694757.9
Nov. 7, 2024 (CN) 202411588131.6

(51) Int. Cl. H01R 4/48

(52) U.S. Cl. CPC H01R 4/48

(57) ABSTRACT

A conductive terminal assembly includes a conductive terminal. The conductive terminal has an end with an insertion portion. The insertion portion has at least one contact unit and an insertion cavity receiving a mating terminal. The at least one contact unit has at least two contact portions for electrical contact with the mating terminal. The at least two contact portions are at intervals in a direction of a central axis of the insertion portion.

### CROSS-REFERENCE TO RELATED APPLICATIONS

This application claims the benefit of the filing date under 35 U.S.C. §119(a)-(d) of Chinese Patent Application No. 202411588131.6, filed on Nov. 7, 2024, and Chinese Patent Application No. 202410694757.9, filed on May 30, 2024, the whole disclosures of which are incorporated herein by reference.

### FIELD OF THE INVENTION

Embodiments of the present disclosure relate to a conductive terminal assembly and, more particularly, to a conductive terminal assembly and a connector including the conductive terminal assembly.

### BACKGROUND OF THE INVENTION

Existing socket-type conductive terminal assemblies typically include a conductive terminal and a sleeve that is sleeved on an outside of the conductive terminal. The sleeve provides a certain holding force to the conductive terminal, ensuring stable contact between the conductive terminal and a mating terminal. However, a contact resistance between the conductive terminal and the mating terminal connected together is relatively high, and the contact stability in an axial direction is poor.

### SUMMARY OF THE INVENTION

A conductive terminal assembly includes a conductive terminal. The conductive terminal has an end with an insertion portion. The insertion portion has at least one contact unit and an insertion cavity receiving a mating terminal. The at least one contact unit has at least two contact portions for electrical contact with the mating terminal. The at least two contact portions are at intervals in a direction of a central axis of the insertion portion.

### BRIEF DESCRIPTION OF DRAWINGS

The invention will now be described by way of example with reference to the accompanying figures, of which:

FIG. 1 is a perspective view of a conductive terminal assembly according to an exemplary embodiment;

FIG. 2 is a side view of the conductive terminal assembly of FIG. 1;

FIG. 3 is a sectional front view of the conductive terminal assembly of FIG. 1;

FIG. 4 is a perspective view of a conductive terminal assembly according to another exemplary embodiment;

FIG. 5 is a perspective view of a conductive terminal assembly according to another exemplary embodiment;

FIG. 6 is a perspective view of a conductive terminal assembly according to another exemplary embodiment;

FIG. 7 is a perspective view of a conductive terminal assembly according to another exemplary embodiment;

FIG. 8 is a perspective view of a conductive terminal assembly according to another exemplary embodiment;

FIG. 9 is a perspective view of a conductive terminal assembly according to another exemplary embodiment;

FIG. 10 is a sectional view of a conductive terminal assembly according to another exemplary embodiment; and

FIG. 11 is a perspective view of a conductive terminal assembly according to another exemplary embodiment.

### DETAILED DESCRIPTION

Although the present disclosure will be fully described with reference to the drawings containing embodiments of the present disclosure, it should be understood that those skilled in the art can modify the description herein to obtain the technical effects of the present disclosure. Therefore, it must be recognized that the below description is a broad revelation to those skilled in the art, and the below description is not intended to limit the exemplary embodiments described herein.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

It should be noted that, the word “comprise” or “include” do not exclude other elements or steps, and the word “a” or “an” do not exclude more than a plurality. In addition, any reference numerals in the claims should not be interpreted as limiting to the scope of the present disclosure.

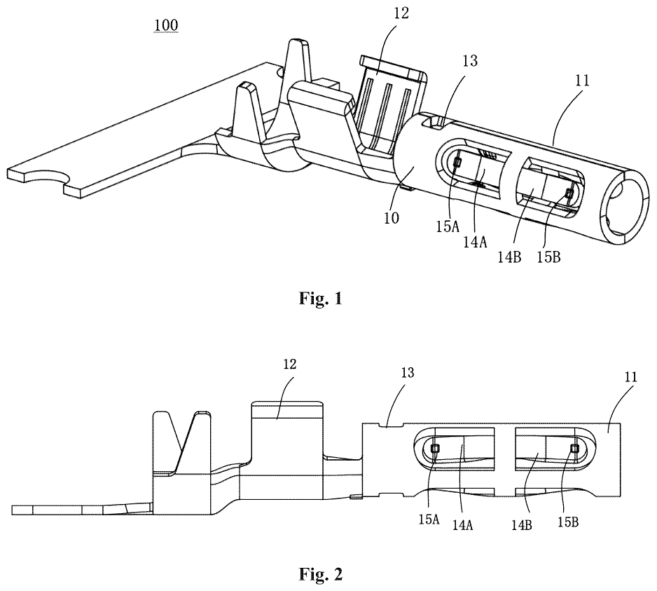

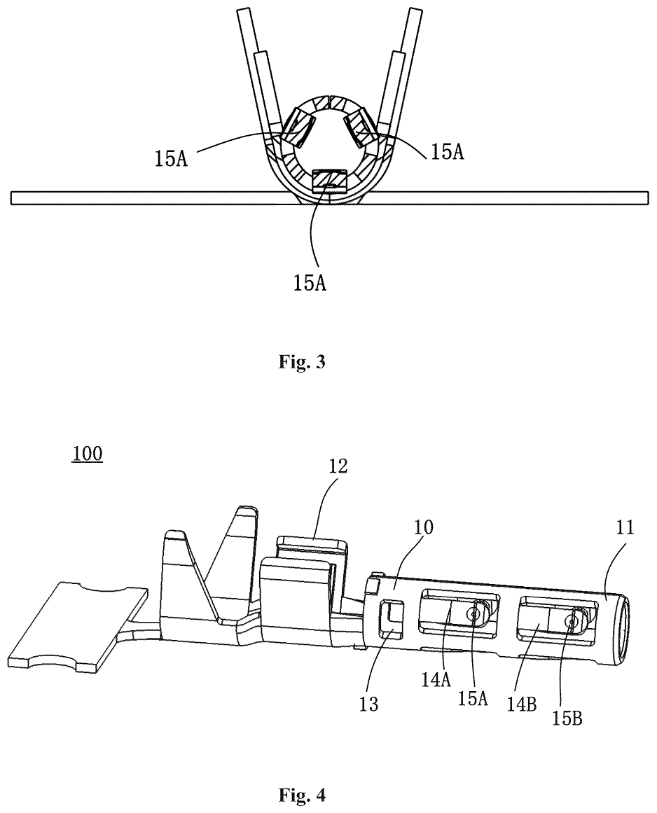

An exemplary embodiment of a conductive terminal assembly 100 will now be described with reference to FIGS. 1-3. As shown in FIG. 1, the conductive terminal assembly 100 includes a conductive terminal 10. One end of the conductive terminal 10 is provided with a cylindrical insertion portion 11, as shown in FIGS. 1-2, which has an insertion cavity for insertion of a mating terminal. In other words, the insertion portion 11 has the insertion cavity which receives the mating terminal. As shown in FIG. 3, for example, the insertion portion 11 of the conductive terminal 10 has three contact units 14, 15 extending along an axial direction, which are provided at equal intervals around the insertion portion 11 so that the entire insertion portion 11 is subjected to forces more evenly, and to prevent the conductive terminal 10 from being easily damaged.

As shown in FIGS. 1-2, each contact unit 14, 15 includes two contact portions for electrical contact with the mating terminal, namely a first contact portion 15A and a second contact portion 15B, which are spaced apart along the central axis of the insertion portion 11. When the mating terminal is inserted into the insertion portion 11, the first contact portion 15A and the second contact portion 15B successively make contact with the mating terminal and form an electrical connection with the mating terminal.

In the conductive terminal assembly 100 according to embodiments of the present disclosure, since at least two contact portions 15A, 15B are provided in the axial direction of the conductive terminal 10, the contact resistance is reduced, and the contact stability of the conductive terminal 10 and the mating terminal in the axial direction is improved, thereby improving the reliability of the connection between the conductive terminal 10 and the mating terminal.

It should be noted that, although three contact units 14, 15 are shown in the embodiment illustrated in FIGS. 1-3, the number of contact units can also be other values, such as one, two, four, etc., in some other embodiments of the present disclosure. Furthermore, although the three contact units 14, 15 are arranged at equal intervals around the insertion portion 11 in the embodiment illustrated in FIGS. 1-3, the plurality of contact units 14, 15 can also be arranged at unequal intervals around the insertion portion 11 in some other embodiments of the present disclosure.

According to the exemplary embodiment shown in FIGS. 1-3, each contact unit 14, 15 includes two contact portions 15A, 15B for electrical contact with the mating terminal. However, in other embodiments of the present disclosure, each contact unit 14, 15 may also include a different number of contact portions 15A, 15B, such as three, four, five, etc., which are arranged at intervals along the central axis of the insertion portion 11 to improve the contact stability between the conductive terminal 10 and the mating terminal in the axial direction.

According to the exemplary embodiment shown in FIGS. 1-3, the insertion portion 11 has a first cantilever 14A and a second cantilever 14B, as shown in FIGS. 1-2. The first cantilever 14A extends obliquely from the approximate middle of the insertion portion 11 away from the insertion portion 11 and towards the central axis of the insertion portion 11. The second cantilever 14B extends obliquely from the approximate middle of the insertion portion 11 towards the insertion opening of the insertion cavity and towards the central axis of the insertion portion 11. As shown in FIGS. 1-2, the first contact portion 15A is provided on the first cantilever 14A, and the first contact portion 15A is a portion of the entire first cantilever 14A closest to the central axis of the insertion portion 11. Similarly, the second contact portion 15B is provided on the second cantilever 14B, and the second contact portion 15B is a portion of the entire second cantilever 14B closest to the central axis of the insertion portion 11.

As shown in FIGS. 1-2, the first cantilever 14A and the second cantilever 14B are connected by a circumferential side wall of the insertion portion 11 at the middle. The first cantilever 14A and the second cantilever 14B extend while tilting towards the central axis of the insertion portion 11, so that when the mating terminal is inserted into the insertion cavity of the insertion portion 11, the first contact portion 15A and the second contact portion 15B abut against the mating terminal. The first contact portion 15A is formed at the free end of the first cantilever 14A, and the second contact portion 15B is formed at the free end of the second cantilever 14B.

Another exemplary embodiment of a conductive terminal assembly 100 will now be described with reference to FIG. 4. As shown in FIG. 4, the insertion portion 11 has a first cantilever 14A and a second cantilever 14B. The first cantilever 14A extends obliquely from one end of the insertion portion 11 distal to the insertion cavity and towards the insertion opening and towards the central axis of the insertion portion 11. The second cantilever 14B extends obliquely from approximately the middle of the insertion portion 11 towards the insertion opening and towards the central axis of the insertion portion 11.

As shown in FIG. 4, the first contact portion 15A is provided on the first cantilever 14A, and the first contact portion 15A is a portion of the entire first cantilever 14A closest to the central axis of the insertion portion 11. Similarly, the second contact portion 15B is provided on the second cantilever 14B, and the second contact portion 15B is a portion of the entire second cantilever 14B closest to the central axis of the insertion portion 11. The first cantilever 14A and the second cantilever 14B are connected together by the circumferential side wall of the insertion portion 11. The first cantilever 14A and the second cantilever 14B extend while tilting towards the central axis of the insertion portion 11, so that when the mating terminal is inserted into the insertion cavity, the first contact portion 15A and the second contact portion 15B abut against the mating terminal. The first contact portion 15A is formed at the free end of the first cantilever 14A, and the second contact portion 15B is formed at the free end of the second cantilever 14B. In this embodiment, by extending obliquely, the first cantilever 14A, which is farthest from the insertion opening of the insertion portion 11, towards the insertion opening and towards the central axis of the insertion portion 11, the distance between the first contact portion 15A, which is farthest from the insertion opening of the insertion portion 11, and the insertion opening is minimized. This results in a shorter engagement length for the mating terminal inserted into the insertion cavity of the conductive terminal 10, thereby reducing the cost of the mating terminal.

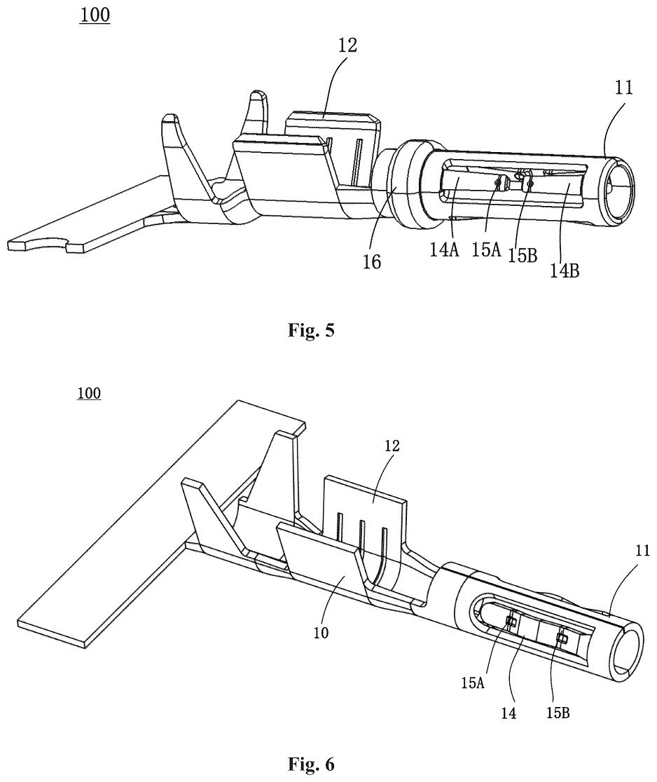

Another exemplary embodiment of a conductive terminal assembly 100 will now be described with reference to FIG. 5. As shown in FIG. 5, the insertion portion 11 has a first cantilever 14A and a second cantilever 14B. The first cantilever 14A extends obliquely from the end of the insertion portion 11 distal to the insertion cavity towards the insertion opening and towards the central axis of the insertion portion 11. The second cantilever 14B extends obliquely from the end of the insertion portion 11 close to the insertion opening away from the insertion opening and towards the central axis of the insertion portion 11.

As shown in FIG. 5, the first contact portion 15A is provided on the first cantilever 14A, and the first contact portion 15A is a portion of the entire first cantilever 14A closest to the central axis of the insertion portion 11. Similarly, the second contact portion 15B is provided on the second cantilever 14B, and the second contact portion 15B is a portion of the entire second cantilever 14B closest to the center axis of the insertion portion 11. The first cantilever 14A and the second cantilever 14B are connected together by the circumferential side wall of the insertion portion 11. The first cantilever 14A and the second cantilever 14B extend while tilting towards the central axis of the insertion portion 11, so that when the mating terminal is inserted into the insertion cavity, the first contact portion 15A and the second contact portion 15B abut against the mating terminal. The first contact portion 15A is formed at the free end of the first cantilever 14A, and the second contact portion 15B is formed at the free end of the second cantilever 14B. In this embodiment, by extending obliquely, the first cantilever 14A, which is farthest from the insertion opening of the insertion portion 11, towards the insertion opening and towards the central axis of the insertion portion 11, the distance between the first contact portion 15A, which is farthest from the insertion opening of the insertion portion 11, and the insertion opening is minimized. This results in a shorter engagement length for the mating terminal inserted into the insertion cavity of the conductive terminal 10, thereby reducing the cost of the mating terminal.

According to another exemplary embodiment, the insertion portion 11 can have a first cantilever 14A and a second cantilever 14B. The first cantilever 14A extends obliquely from the approximate middle of the insertion portion 11 away from the insertion opening and towards the central axis of the insertion portion 11. The second cantilever 14B extends obliquely from the end of the insertion portion 11 close to the insertion opening and away from the insertion opening and towards the central axis of the insertion portion 11. In this embodiment, the first contact portion 15A is provided on the first cantilever 14A, and the first contact portion 15A is a portion of the entire first cantilever 14A closest to the central axis of the insertion portion 11. Similarly, the second contact portion 15B is provided on the second cantilever 14B, and the second contact portion 15B is a portion of the entire second cantilever 14B closest to the central axis of the insertion portion 11. That is to say, both the first cantilever 14A and the second cantilever 14B extend away from the insertion opening along the direction of the central axis of the insertion portion 11, and both the first cantilever 14A and the second cantilever 14B extend while tilting towards the central axis of the insertion portion 11, so that when the mating terminal is inserted into the insertion cavity, the first contact portion 15A and the second contact portion 15B abut against the mating terminal. The first contact portion 15A is provided at the free end of the first cantilever 14A, and the second contact portion 15B is provided at the free end of the second cantilever 14B.

It should be noted that, although the first cantilevers 14A of all the contact units 14, 15 are aligned in the circumferential direction of the insertion portion 11, the first contact portion 15A is also aligned in the circumferential direction of the insertion portion 11, the second cantilevers 14B of all the contact units are aligned in the circumferential direction of the insertion portion 11, and the second contact portion 15B is also aligned in the circumferential direction of the insertion portion 11 in the embodiments shown in FIGS. 3, 4, and 5. In various other embodiments, the first cantilevers 14A of all the contact units and the first contact portion 15A can also be offset from each other in the circumferential direction of the insertion portion 11, and the second cantilevers 14B of all the contact units and the second contact portion 15B can also be offset from each other in the circumferential direction of the insertion portion 11.

Another exemplary embodiment of a conductive terminal assembly 100 will now be described with reference to FIG. 6. As shown in FIG. 6, the insertion portion 11 has a third cantilever 14, which extends obliquely from one end of the insertion portion 11 close to the insertion opening away from the insertion opening and towards the central axis of the insertion portion 11. As shown in FIG. 6, both the first contact portion 15A and the second contact portion 15B are provided on the third cantilever 14. It should be noted that in some other embodiments of the present disclosure, the third cantilever 14 can also extend obliquely from one end of the insertion portion 11 distal to the insertion opening and towards the central axis of the insertion portion 11.

It should also be noted that, while the third cantilevers 14, the first contact portion 15A, and the second contact portion 15B of all the contact units are aligned in the circumferential direction of the insertion portion 11 in the embodiment shown in FIG. 6, the third cantilevers 14, the first contact portion 15A and the second contact portion 15B of all the contact units can also be offset from each other in the circumferential direction of the insertion portion 11 in some other embodiments of the present disclosure.

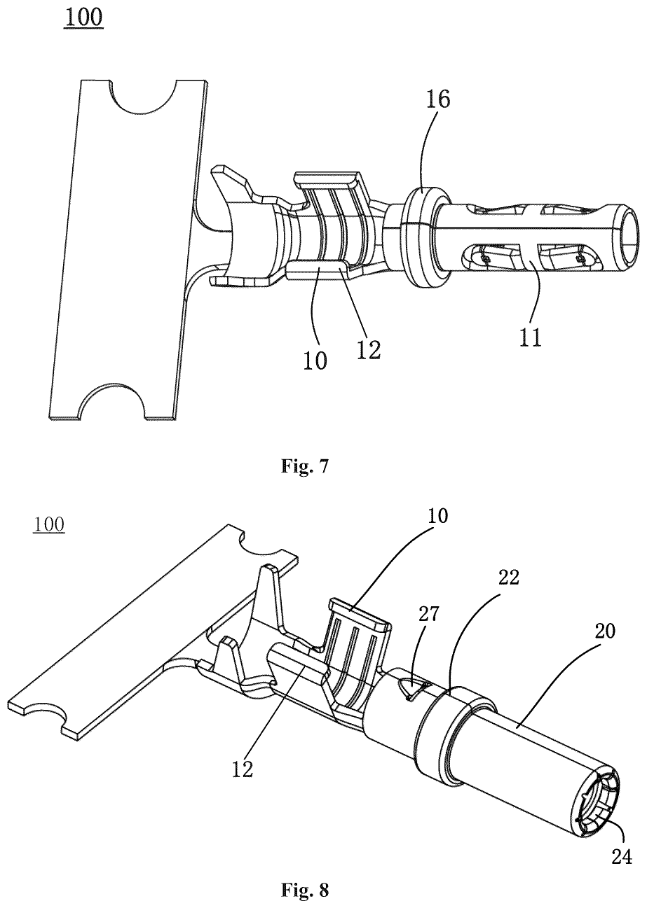

Another exemplary embodiment of a conductive terminal assembly 100 will now be described with reference to FIG. 7. As shown in FIG. 7, a portion of the third cantilever 14 located between the first contact portion 15A and the second contact portion 15B protrudes outwardly from the central axis of the insertion portion 11. The first contact portion 15A and the second contact portion 15B protrude outwardly to, for example, abut against a sleeve 20 outside the insertion portion 11 or a housing of the connector. This allows a force to be applied to the third cantilever 14 by the sleeve 20 or the housing, thereby ensuring the stable contact between the two contact portions and the mating terminal.

As shown in FIGS. 1-2 and 4-11, according to the exemplary embodiments of the present disclosure, the conductive terminal 10 further includes a wiring portion 12 located at an end opposite to the insertion portion 11 and an intermediate portion connecting the insertion portion 11 and the wiring portion 12. The wiring portion 12 is U-shaped to fixedly hold and electrically connect the cable.

According to the exemplary embodiments shown in FIGS. 5 and 7, a locking boss 16 is provided on the conductive terminal 10, which can be engaged with the housing of the connector to fix the conductive terminal assembly 100 inside the housing of the connector.

According to the exemplary embodiments shown in FIGS. 8-11, the conductive terminal assembly 100 further includes a sleeve 20 that is sleeved on the outside of the insertion portion 11. The sleeve 20 can provide a certain holding force to the conductive terminal 10 to maintain the stable contact between the conductive terminal 10 and the mating terminal.

According to the exemplary embodiments of the present disclosure, as shown in FIGS. 8 and 9, the sleeve 20 includes a substantially cylindrical sleeve body 21 and a circumferential locking boss 22 that protrudes radially and outwardly from the sleeve body 21. The circumferential locking boss 22 can be engaged with the housing of the connector to secure the conductive terminal assembly 100 within the housing of the connector. In the exemplary embodiment of the present disclosure, the conductive terminal assembly 100 is secured within the housing of the connector by forming the circumferential locking boss 22 on the sleeve 20 that is engaged with the housing of the connector. This avoids machining of a boss on the conductive terminal 10, which helps reduction of the length of the terminal, thereby lowering a cost. In addition, since the material hardness of the sleeve 20 is typically greater than that of the conductive terminal 10 and the thickness of the sleeve 20 is typically less than that of the conductive terminal 10, a metal sliver issue is reduced or eliminated during the processing of the conductive terminal assembly 100.

According to another exemplary embodiment, the circumferential locking boss 22 includes a first circumferential locking boss 22 and a second circumferential locking boss 22 spaced apart along the axial direction of the sleeve 20. In this way, the first circumferential locking boss 22 can be engaged with the housing of the connector to form a primary locking structure that locks the conductive terminal assembly 100 to the housing of the connector. At the same time, the second circumferential locking boss 22 can also be engaged with the housing of the connector to form a secondary locking structure that locks the conductive terminal assembly 100 to the housing of the connector. It should be noted that in other embodiments of the present disclosure, the number of the circumferential locking bosses 22 can also be other values, such as three or four, and the specific number can be designed according to the specific situation.

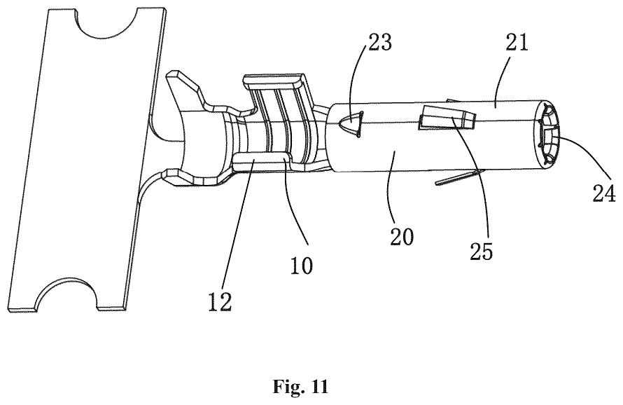

According to the exemplary embodiment shown in FIG. 11, the sleeve 20 is provided with a sleeve clip 25 that extends obliquely from the sleeve body 21 away from the insertion opening and away from the central axis of the insertion portion 11. The sleeve clip 25 can be engaged with the housing of the connector to secure the conductive terminal assembly 100 within the housing of the connector.

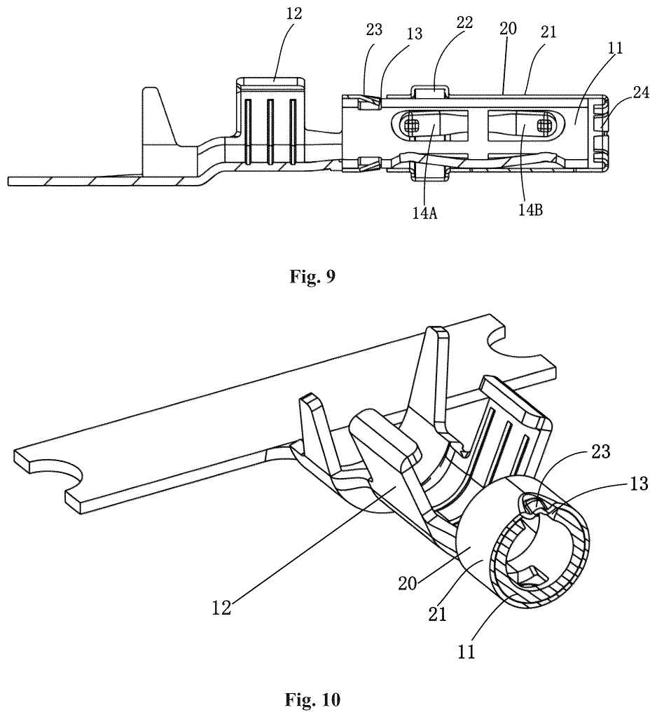

According to exemplary embodiments of the present disclosure, as shown in FIGS. 9-11, the conductive terminal assembly 100 also includes a locking structure for securing the sleeve body 21 to the conductive terminal 10. Specifically, as shown in FIGS. 9-10, the locking structure includes a groove 13 formed in the conductive terminal 10, and, as shown in FIGS. 9-11, a clip 23 formed on the side wall of the sleeve 20. The sleeve 20 can be fixed to the conductive terminal 10 by the engagement of the clip 23 and the groove 13. It should be noted that in some other embodiments of the present disclosure, the clip 23 of the locking structure can be formed on the conductive terminal 10, and the groove 13 can be formed in the side wall of the sleeve 20. The groove 13 may be a clamping groove 13, and the clip 23 may be a clamping clip 23.

According to an exemplary embodiment of the present disclosure, as shown in FIG. 9, there is a plurality of locking structures 13, 23. The plurality of locking structures 13, 23 are provided at intervals along the circumferential direction of the sleeve 20 to increase the holding force, thereby improving reliability of the connection between the conductive terminal 10 and the mating terminal, and making the entire insertion portion 11 more uniformly stressed in the circumferential direction.

According to another exemplary embodiment, the plurality of locking structures 13, 23 can also be provided at intervals along the axial direction of the sleeve 20 to increase the holding force, thereby improving reliability of the connection between the conductive terminal 10 and the mating terminal, and making the entire insertion portion 11 more uniformly stressed in the axial direction.

According to the exemplary embodiment of the present disclosure shown in FIG. 8, one end of the sleeve 20 away from the insertion opening of the insertion cavity is formed with a protruding portion 27 extending towards the conductive terminal 10 to increase the thickness of the sleeve 20 and thus increase the holding force provided by the sleeve 20 for the conductive terminal 10.

According to exemplary embodiments of the present disclosure, as shown in FIGS. 8-9 and 11, one end of the sleeve 20 corresponding to the insertion opening of the insertion cavity of the conductive terminal 10 is bent into the insertion cavity to form a stopper 24, which is used to stop the forward movement of the conductive terminal 10.

According to an exemplary embodiment of the present disclosure, the sleeve 20 can be formed by bending a metal sheet. In addition, in order to ensure the strength of the sleeve 20, the material of the sleeve 20 is a stainless steel. In other embodiments, the sleeve 20 can also be made from other metal materials, such as metal materials with greater hardness and less thickness than the conductive terminal 10.

According to an exemplary embodiment of the present disclosure, as shown in FIG. 9, the clip 23 can be embedded into the groove 13 by a stamping technology. Since the sleeve 20 can be formed by bending rather than drawing-deep, this allows the stamping process and the assembly process to be integrated into a single mold. This significantly reduces the requirements for the roundness and dimensional variations of the two parts, thereby greatly reducing the manufacturing difficulty of the parts and ensuring more stable product quality.

According to another aspect of the present disclosure, a connector is also provided, which includes a housing and a conductive terminal assembly fixed in the housing, the conductive terminal assembly being the conductive terminal assembly 100 according to embodiments of the present disclosure.

In the conductive terminal assembly 100 and the connector according to the various abovementioned embodiments of the present disclosure, with the provision of the at least two contact portions in the axial direction of the conductive terminal 10, the contact resistance is reduced, and the contact stability between the conductive terminal 10 and the mating terminal in the axial direction is improved, thereby improving the reliability of the connection between the conductive terminal 10 and the mating terminal.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate embodiments of the present disclosure by way of example, and should not be construed as a limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

1. A conductive terminal assembly, comprising
a conductive terminal having an end with an insertion portion, the insertion portion has at least one contact unit and an insertion cavity receiving a mating terminal, the at least one contact unit has at least two contact portions electrical contacting the mating terminal, the at least two contact portions are at intervals in a direction of a central axis of the insertion portion.

2. The conductive terminal assembly of claim 1, wherein the at least one contact unit includes a plurality of contact units, the plurality of contact units are at intervals in a circumferential direction of the insertion portion.

3. The conductive terminal assembly of claim 1, wherein the insertion portion has a first cantilever and a second cantilever, the first cantilever extends obliquely from a middle of the insertion portion away from an insertion opening and towards the central axis, the second cantilever extends obliquely from the middle of the insertion portion towards the insertion opening and towards the central axis.

4. The conductive terminal assembly of claim 3, wherein the first cantilever has a first contact portion of the at least two contact portions, and the second cantilever has a second contact portion of the at least two contact portions.

5. The conductive terminal assembly of claim 1, wherein the insertion portion has a first cantilever and a second cantilever, both the first cantilever and the second cantilever extend obliquely towards an insertion opening and towards the central axis, the first cantilever has a first contact portion of the at least two contact portions, and the second cantilever has a second contact portion of the at least two contact portions.

6. The conductive terminal assembly of claim 1, wherein the insertion portion has a first cantilever and a second cantilever, the first cantilever extends obliquely from an end of the insertion portion distal to the insertion cavity towards an insertion opening and towards the central axis, the second cantilever extends obliquely from an end of the insertion portion close to the insertion opening away from the insertion opening and towards the central axis.

7. The conductive terminal assembly of claim 6, wherein the first cantilever has a first contact portion of the at least two contact portions, and the second cantilever has a second contact portion of the at least two contact portions.

8. The conductive terminal assembly of claim 1, wherein the insertion portion has a first cantilever and a second cantilever, both the first cantilever and the second cantilever extend obliquely away from an insertion opening and towards the central axis, the first cantilever has a first contact portion of the at least two contact portions, and the second cantilever has a second contact portion of the at least two contact portions.

9. The conductive terminal assembly of claim 1, wherein the insertion portion has a cantilever extending obliquely towards an insertion opening and towards the central axis, the cantilever has a first contact portion and a second contact portion of the at least two contact portions.

10. The conductive terminal assembly of claim 1, wherein the insertion portion has a cantilever extending obliquely away from an insertion opening and towards the central axis, the cantilever has a first contact portion and a second contact portion of the at least two contact portions.

11. The conductive terminal assembly of claim 10, wherein a portion of the cantilever between the first contact portion and the second contact portion protrudes outwardly away from the central axis.

12. The conductive terminal assembly of claim 1, further comprising a locking boss protruding radially and outwardly from the conductive terminal.

13. The conductive terminal assembly of claim 1, further comprising a sleeve sleeved on an outside of the insertion portion.

14. The conductive terminal assembly of claim 13, wherein the sleeve includes a sleeve body and:
a circumferential locking boss protruding radially and outwardly from the sleeve body; or
a sleeve clip extending obliquely from the sleeve body away from an insertion opening and away from the central axis.

15. The conductive terminal assembly of claim 14, further comprising a locking structure fixing the sleeve body and the conductive terminal together.

16. The conductive terminal assembly of claim 15, wherein the locking structure has a groove formed in the insertion portion and a clamping clip formed on a side wall of the sleeve body, the sleeve body is fixed on the conductive terminal by engagement of the clamping clip and the groove.

17. The conductive terminal assembly of claim 15, wherein the locking structure is one of a plurality of locking structures, the plurality of locking structures are arranged at intervals in a circumferential direction of the sleeve body.

18. The conductive terminal assembly of claim 1, further comprising a sleeve sleeved on an outside of the insertion portion, the sleeve including a sleeve body, a circumferential locking boss protruding radially and outwardly from the sleeve body, and a sleeve clip extending obliquely from the sleeve body away from an insertion opening and away from the central axis.

19. A connector, comprising:
a housing; and
a conductive terminal assembly fixed in the housing, the conductive terminal assembly including a conductive terminal having an end with an insertion portion, the insertion portion has at least one contact unit and an insertion cavity receiving a mating terminal, the at least one contact unit has at least two contact portions electrically contacting the mating terminal, the at least two contact portions are at intervals in a direction of a central axis of the insertion portion.
